(19) United States
(12) Patent Application Publication
(10) Pub. No.: US 2005/0029427 A1
(43) Pub. Date: Feb. 10, 2005

(54) Mounting system for electric machines

(75) Inventors: Harold C. Kingrey, Huntington, IN (US); Harald E. Blaettner, Fort Wayne, IN (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: General Electric Company

(21) Appl. No.: 10/638,034

(22) Filed: Aug. 8, 2003

(51) Int. Cl. F16M 1/00

(52) U.S. Cl. 248/638

(57) ABSTRACT

A mounting system for securing an electric machine to a surface is provided. The mounting system includes a first isolation member, a second isolation member, a first support member, and a second support member. The first and second support members each have a first portion and a second portion. The second portions are securable to the surface so that the first isolation member is positioned between the first support member and the surface and the second isolation member is positioned between the second support member and the surface. The first and second support members are securable to one another so that the first portion of the first and second support members are mated with third portions of the electric machine.

### BACKGROUND OF THE INVENTION

This disclosure is related to a mounting system. More particularly, this disclosure is related to a mounting system for electric machines.

Mounting systems are commonly used to mount electric machines such as motors, generators, starters and the like to a desired surface. Typically, such mounting systems are also configured to aid in isolating the transmission of noise and/or vibration from the electric machine to the desired surface.

The desired surface can be, for example, in an appliance such as a refrigerator, a dishwasher, a washing machine, a clothes dryer, and others. In these types of applications, the mounting system's ability to isolation noise and/or vibration can be important to the aesthetic characteristics of the appliance. The mounting system's ability to isolation vibration can also be important to the longevity of the appliance.

In addition to the aesthetic and functional aspects the mounting system imparts to the appliance, the competitive success of consumer products such as appliances can be highly dependent on cost. The cost of the mounting system can depend on the cost of the individual components of the system, the time required to assemble the system, and combinations thereof.

Accordingly, a continuing need exists for a mounting system for electrical machines that is cost efficient, easy to configure, and reduces noise and vibration.

### SUMMARY OF THE INVENTION

A mounting system for securing an electric machine to a surface is provided. The mounting system includes a first isolation member, a second isolation member, a first support member, and a second support member. The first and second support members each have a first portion and a second portion. The second portions are securable to the surface so that the first isolation member is positioned between the first support member and the surface and the second isolation member is positioned between the second support member and the surface. The first and second support members are securable to one another so that the first portion of the first and second support members are mated with third portions of the electric machine.

A mounting system having a pair of support members, a first isolation member, and a second isolation member is provided. Each support member has a first portion connectable to an electric machine and a second portion connectable to a surface. The first isolation member positioned between the surface and the second portion of a first support member of the pair of support members. The second isolation member is positioned between the surface and the second portion of a second support member of the pair of support members. The first support member is securable to the second support member so that the electric machine is compressed between the first and second support members when the first and second support members are secured together.

A mounting system for securing an electric machine to a surface having a first vibration isolating member, a second vibration isolating member, a first support member, and a second support member is provided. The first support member has a first lip and a first base. Similarly, the second support member has a second lip and a second base. The first lip is mateable with a first channel of the electric machine and the second lip is mateable with a second channel of the electric machine. The first base is connectable to the surface so that the first vibration-isolating member is disposed therebetween and the second base is connectable to the surface so that the second vibration-isolating member is disposed therebetween.

The above-described and other features and advantages will be appreciated and understood by those skilled in the art from the following detailed description, drawings, and appended claims.

### BRIEF DESCRIPTION OF THE DRAWINGS

FIG. 1 is a perspective view of a typical mounting system;

FIG. 2 is a top perspective view of an exemplary embodiment of a mounting system;

FIG. 3 is side perspective view of the mounting system of FIG. 2; and

FIG. 4 illustrates the mounting system of FIG. 2 in an unassembled state.

### DETAILED DESCRIPTION OF THE INVENTION

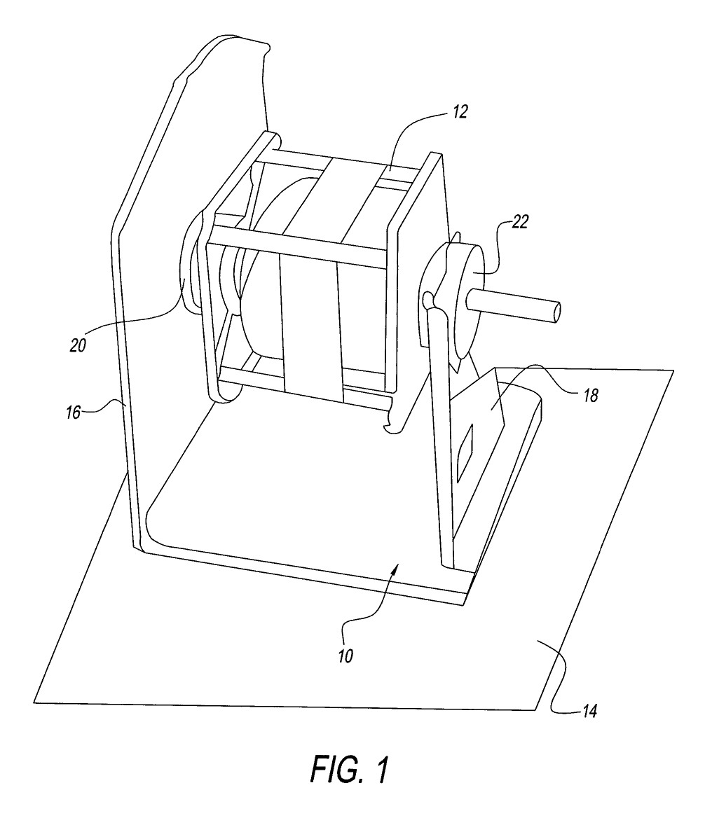

Referring now to the drawings, and in particular to FIG. 1, a typical mounting system 10 is illustrated. Mounting system 10 is configured to mount or secure an electric machine 12 to a desired surface 14 in an apparatus (not shown), such as a dishwasher, an air conditioner, a clothes dryer, an automobile, and others. Electric machine 12 can be a motor, a generator, a motor/generator, and the like.

Mounting system 10 includes a first support member 16 and a second support member 18 each securable to surface 14. Mounting system 10 also includes a first resilient ring 20 and a second resilient ring 22. First resilient ring 20 is positioned between first support member 16 and electric machine 12. Similarly, second resilient ring 22 is positioned between second support member 18 and electric machine 12. Resilient rings 20, 22 are configured to mitigate the transmission of noise and vibration from electric machine 12 to surface 14 through first and second support members 16, 18, respectively. Thus, mounting system 10, in effect, suspends electric machine 12 from resilient rings 20, 22.

In vibration control techniques, it is common to minimize the mass (e.g., weight) of the object that the resilient member is isolating, while maximizing the mass of object that of the remaining portion of the system. In this manner, the ability of vibration in the isolated object to effect the remaining portions of the system is minimized. Mounting system 10 follows this technique. Specifically, resilient rings 20, 22 of mounting system 10 are positioned between electric machine 12 and first and second support members 16, 18. Thus, the only mass resilient rings 20, 22 are required to isolate is that of electric machine. Further, the mass of first and second support members 16, 18 is added to that of surface 14, and not electric machine 12.

Unfortunately, mounting system 10 has several deleterious effects. For example, resilient rings 20, 22 are expensive to manufacture and are difficult to assemble in support members 16, 18.

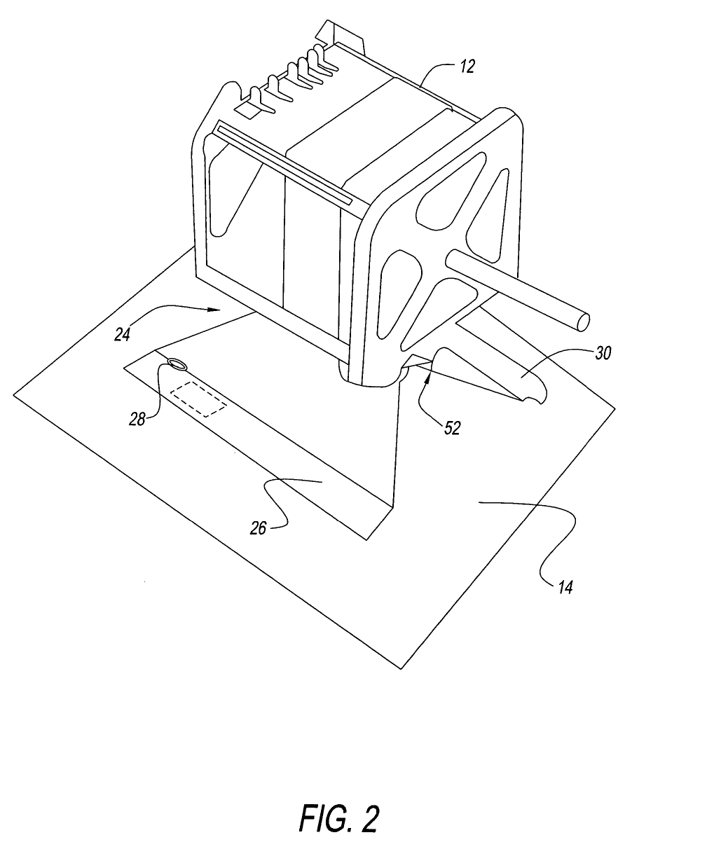

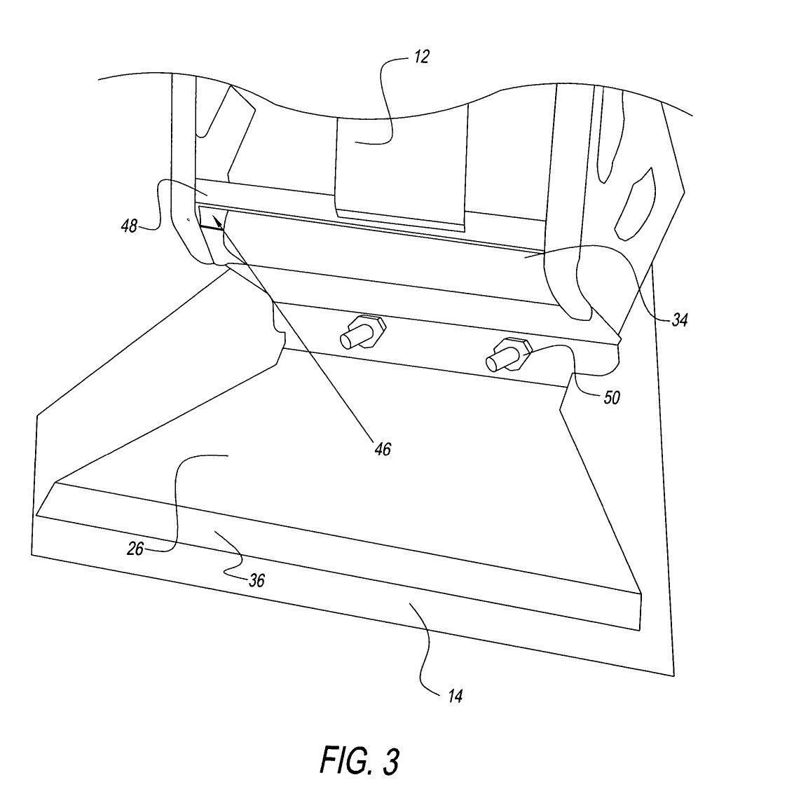

An exemplary embodiment of a mounting system 24 according to the present disclosure is illustrated in FIGS. 2-4. Mounting system 24 is configured to secure electric machine 12 to surface 14. Advantageously, mounting system 24 overcomes one or more of the deficiencies of the typical mounting system 10. For example, mounting system 24 is less costly and more easily assembled than typical mounting system 10. In addition, it has been found that mounting system 24 also has increased vibration-dampening characteristics as compared to typical mounting system 10. Thus, mounting system 24 is less costly and performs better than the typical mounting system 10.

Mounting system 24 is described by way of simultaneous reference to FIGS. 2-4. Mounting system 24 includes a first support member 26, a first isolation member 28, a second support member 30, and a second isolation member 32. Each support member 26, 30 defines a first portion 34 securable to electric machine 12 and a second portion 36 securable to surface 14.

Each second portion 36 can include a pair of first securing members 38 for securing support members 26, 30 to surface 14. In the illustrated embodiment, second portion 36 is a base extending from first and second support members 26, 30. Here, first securing members 38 are illustrated as a tab 40 and a bolt-hole 42 defined in the base 36. Tab 40 is configured to be received in a slot (not shown) defined in surface 14. Hole 42 is configured to receive a mechanical fastener 44, such as a bolt, securable to surface 14.

It should be recognized that first securing members 38 are illustrated by way of example as tab 40 and bolt-hole 42. Of course, other first securing members 38 such as, but not limited to, mechanical fastening members, thermal fastening members (e.g., welding), adhesive fastening members, and others are contemplated by the present disclosure.

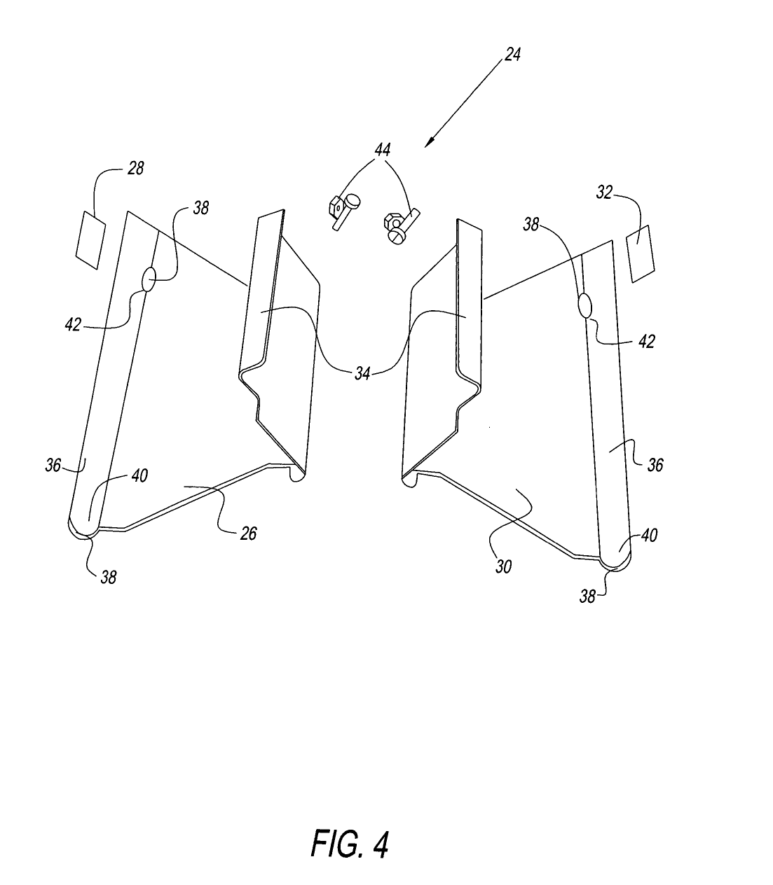

It should also be recognized that first and second support members 26, 30 are illustrated by way of example as having a shape that is a mirror image of one another (illustrated in FIG. 4). Of course, it is contemplated by the present disclosure for first and second support members 26, 30 to be identical in shape or dissimilar in shape.

Isolation members 28, 32 are disposed between second portion 36 and surface 14 to isolate electric machine 12 from the surface. Isolation members 28, 32 can be made from any resilient material including, but not limited to rubber, plastic, a rubber/metal composite, a plastic/metal composite, and any combinations thereof. In this manner, isolation system 24, in effect, supports support members 26, 30 and electric machine 12 with isolation members 28, 32, respectively.

In the exemplary embodiment illustrated, first isolation member 28 is disposed between first support member 26 and surface 14 at hole 42. Similarly, second isolation member 32 is disposed between second support member 30 and surface 14 at hole 42. Of course, it is contemplated by the present disclosure for isolation members 28, 32 to extend completely along second portion 36 of first and second support members 26, 30 or any portion thereof.

It has been found that locating isolation members 28, 32 between first and second support members 26, 30 and surface 14 is effective in isolating vibration from electric machine 12 to the surface. Specifically, it has been found, contrary to the typical vibration control techniques used by mounting system 10, that positioning isolation members 28, 32 between second portion 36 and surface 14 provides increased vibration isolation as compared to that of the typical mounting system 10.

Further, it has also been found that isolation members 28, 32 are significantly less expensive and easier to assemble than resilient rings 20, 22 of typical mounting system 10. Consequently, mounting system 24 is about 5 times less expensive than typical mounting system 10. Thus, mounting system 24 provides improved performance at a lower cost that possible from the typical mounting system 10.

First portion 34 is configured to mate with a third portion 46 defined in electric machine 12. For example, electric machine 12 can have a support frame having a number of beams 48 each having third portion 46 defined therein. First support member 26 is positioned so that its first portion 34 mates with one third portion 46, while second support member 30 is positioned so that its first portion 34 mates with the other third portion 46. First and second supporting members 26, 30 are secured to one another such first portions 34 are secured to third portions 46, respectively. In this manner, mounting system 24 compresses electric machine 12 between first and second supporting members 26, 30.

First and second supporting members 26, 30 can be secured to one another by second securing members 50. In this position, first and second support members 26, 30 can define an X-shaped support structure 52. Second securing members 50 can be securing members such as, but not limited to, mechanical fastening members, thermal fastening members (e.g., welding), adhesive fastening members, and any combination thereof.

In the illustrated embodiment, first portion 34 is a lip extending from first and second support members 26, 30, while third portion 46 is a channel defined in electric machine 12. Here, lips 34 are received in channels 46. In addition, lips 34 are illustrated extending continuously across first and second securing members 26, 30 and as being received in channels 46 running continuously across electric machine 12. Of course, it is contemplated for first and third portions 34, 46 to have any shape mateable with one another so that electric machine 12 is compressed by first and second support members 26, 30.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the disclosure without departing from the essential scope thereof. Therefore, it is intended that the invention not be limited to the particular embodiment(s) disclosed as the best mode contemplated for carrying out this invention, but that the invention will include all embodiments falling within the scope of the appended claims.

1. A mounting system for securing an electric machine to a surface, comprising:
a first isolation member;
a second isolation member;
a first support member; and
a second support member, said first and second support members each having a first portion and a second portion, said second portion of said first and second support members being each securable to said surface so that said first isolation member is positioned between said first support member and said surface and said second isolation member is positioned between said second support member and said surface, and said first and second support members being securable to one another so that said first portion of said first and second support members are mated with third portions of said electric machine.

2. The mounting system as in claim 1, wherein said first support member has a first shape and said second support member has a second shape.

3. The mounting system as in claim 2, wherein said first and second shapes are mirror images of one another.

4. The mounting system as in claim 2, wherein said first and second shapes are identical to one another.

5. The mounting system as in claim 1, wherein said first portion is a lip.

6. The mounting system as in claim 1, wherein said second portion of each of said first and second support members comprises a securing member for securing said first and second support members to said surface, respectively.

7. The mounting system as in claim 6, wherein said first isolation member is positioned between said first support member and said surface at least at said securing member of said first support member and said second isolation member is positioned between said second support member and said surface at least at said securing member of said second support member.

8. A mounting system comprising:
a pair of support members each having a first portion connectable to an electric machine and a second portion connectable to a surface;
a first isolation member positioned between said surface and said second portion of a first support member of said pair of support members; and
a second isolation member positioned between said surface and said second portion of a second support member of said pair of support members, said first support member being securable to said second support member so that said electric machine is compressed between said first and second support members when said first and second support members are secured together.

9. The mounting system as in claim 8, wherein said first support member has a first shape and said second support member has a second shape.

10. The mounting system as in claim 9, wherein said first and second shapes are mirror images of one another.

11. The mounting system as in claim 10, wherein said first and second shapes form an X-like support structure.

12. The mounting system as in claim 9, wherein said first and second shapes are identical to one another.

13. A mounting system for securing an electric machine to a surface, comprising:
a first vibration isolating member;
a second vibration isolating member;
a first support member having a first lip and a first base, said first lip being mateable with a first channel of said electric machine, said first base being connectable to said surface so that said first vibration isolating member is disposed therebetween; and
a second support member having a second lip and a second base, said second lip being mateable with a second channel of said electric machine, said second base being connectable to said surface so that said second vibration isolating member is disposed therebetween.

14. The mounting system as in claim 13, wherein said first and second support members are securable to one another so that said electric machine is compressed between said first and second support members.

15. The mounting system as in claim 14, wherein said first and second shapes form an X-like support structure when secured to one another.

16. The mounting system as in claim 15, wherein said first support member has a first shape and said second support member has a second shape.

17. The mounting system as in claim 16, wherein said first and second shapes are mirror images of one another.

18. The mounting system as in claim 16, wherein said first and second shapes are identical to one another.

19. The mounting system as in claim 15, wherein said first and second vibration isolating members are positioned between said first and second support members and said surface at least at a point of securement between said first and second support members and said surface, respectively.
